(19) United States
(12) Patent Application Publication
(10) Pub. No.: US 2025/0104490 A1
(43) Pub. Date: Mar. 27, 2025

(54) DEVICE AND METHOD FOR DETECTING ABNORMALITY OF A STEERING MOTOR, AND COMPUTER-READABLE STORAGE MEDIUM STORING PROGRAM FOR PERFORMING THE METHOD

(71) Applicant: HL MANDO CORPORATION, Gyeonggi-do (KR)

(72) Inventors: Gyuwon KIM, Gyeonggi-do (KR); Jongick WON, Gyeonggi-do (KR)

(21) Appl. No.: 18/893,770

(22) Filed: Sep. 23, 2024

(30) Foreign Application Priority Data
Sep. 22, 2023 (KR) 10-2023-0127145
May 8, 2024 (KR) 10-2024-0060707

(51) Int. Cl. G07C 5/08; B62D 5/00; G05B 13/02

(52) U.S. Cl. CPC G07C 5/0808; B62D 5/006; G05B 13/027

(57) ABSTRACT

Disclosed are a steering motor abnormality detection device and method and a non-transitory computer-readable storage medium in which a program for performing the method is stored. The steering motor abnormality detection device includes a memory in which one or more instructions are stored and a processor configured to execute the one or more instructions, wherein the processor executes the one or more instructions to input an input value related to driving of a rack to an artificial neural network model, obtain one or more estimation values related to steering output by the artificial neural network model, and compare the one or more estimation values with one or more actual measurement values related to the steering to detect whether the steering motor is abnormal, wherein the rack receives a driving force from a wheel actuator driven to correspond to the manipulation of the steering wheel and moves a wheel of the vehicle.

### CROSS-REFERENCE TO RELATED APPLICATIONS

This application claims priority to and the benefit of Korean Patent Application No. 10-2023-0127145, filed on Sep. 22, 2023, and Korean Patent Application No. 10-2024-0060707, filed on May 8, 2024, the disclosures of which are incorporated herein by reference in their entireties.

### TECHNICAL FIELD

The present disclosure relates to a steering motor abnormality detection device and method and a non-transitory computer-readable storage medium in which a program for performing the method is stored, and more specifically, to a steering motor abnormality detection device and method for detecting the performance degradation of a steering motor, which is disposed in a steer-by-wire system of a vehicle and provides a reaction force against manipulation of a steering wheel, and a non-transitory computer-readable storage medium in which a program for performing the method is stored.

### RELATED ART

A steer-by-wire system is a steering system which transmits a steering intention of a driver to a wheel of a vehicle through an electric signal without mechanical connection between a steering wheel of the vehicle and the wheel of the vehicle. The steer-by-wire system prevents generation of unnecessary vibrations and the like and improves accuracy and responsiveness of steering by minimizing the mechanical connection. In addition, the steer-by-wire system provides a high degree of freedom in a viewpoint of layout and facilitates common use of parts and the like.

A steer-by-wire system includes a steering feeling actuator (SFA) for providing a reaction force of a steering wheel to a driver of a vehicle and a road wheel actuator (RWA) for transmitting a steering intention of the driver to a wheel of the vehicle to move the wheel. Generally, The SFA and the RWA are provided as motors.

The motor constituting the SFA may be provided as a permanent magnet synchronous motor (PMSM). An output torque of the PMSM is gradually reduced due to demagnetization or the like caused by degradation.

When the output torque of the SFA is reduced, the driver should have a feedback of different ride comfort from the steering intention of the driver. Such different feedback causes an accident due to steering errors. Accordingly, the development of a technology allowing abnormality of a motor to be prognosed instead of post-diagnosing of a failure is required to improve the stability of the steer-by-wire system.

### SUMMARY

The present disclosure is directed to solving the above-described problems and providing a steering motor abnormality detection device and method for detecting the performance degradation of a steering motor disposed in a steer-by-wire system of a vehicle and configured to provide a reaction force against manipulation of a steering wheel and a non-transitory computer-readable storage medium in which a program for performing the method is stored.

The present disclosure is also directed to providing a steering motor abnormality detection device and method for effectively detecting output reduction of a steering motor in advance without using an additional sensor in addition to a sensor, which is disposed in the conventional vehicle, in a vehicle and a non-transitory computer-readable storage medium in which a program for performing the method is stored.

The objects of the present disclosure are not limited to the above-described objects, and other objects that are not mentioned will be able to be clearly understood by those skilled in the art to which the present disclosure pertains from the following description.

In accordance with one aspect of the present disclosure, there is provided a steering motor abnormality detection device for detecting abnormality of a steering motor disposed in a steer-by-wire system of a vehicle and configured to provide a reaction force against manipulation of a steering wheel, the steering motor abnormality detection device including a memory in which one or more instructions are stored and a processor configured to execute the one or more instructions, wherein the processor executes the one or more instructions to input an input value related to driving of a rack to an artificial neural network model, obtain one or more estimation values related to steering output by the artificial neural network model, and compare the one or more estimation values with one or more actual measurement values related to the steering to detect whether the steering motor is abnormal, wherein the rack receives a driving force from a wheel actuator driven to correspond to the manipulation of the steering wheel and moves a wheel of the vehicle.

In the steering motor abnormality detection device according to one aspect of the present disclosure, the input value may be a propulsive force of the rack.

In the steering motor abnormality detection device according to one aspect of the present disclosure, the one or more estimation values may include a first estimation value for a first residual which is a difference between a command value of a steering torque applied to the steering wheel of the vehicle to correspond to the input value and a measurement value of the steering torque, and the one or more actual measurement values may include a first actual measurement value which is an actual measurement value for the first residual.

In the steering motor abnormality detection device according to one aspect of the present disclosure, the one or more estimation values may further include a second estimation value for a second residual which is a difference between a command value of a motor torque transmitted to the steering motor to correspond to the input value and a measurement value of the motor torque, and the one or more actual measurement values may further include a second actual measurement value which is an actual measurement value for the second residual.

In the steering motor abnormality detection device according to one aspect of the present disclosure, the input value may be obtained through a controller area network (CAN) of the vehicle.

In the steering motor abnormality detection device according to one aspect of the present disclosure, the artificial neural network model may be formed in a generative adversarial network (GAN) including a generator configured to receive the input value and generate the one or more estimation values and a discriminator configured to receive the input value and actual measurement data including the one or more actual measurement values and output a discrimination value for the actual measurement data.

In the steering motor abnormality detection device according to one aspect of the present disclosure, the generator may be provided as a multivariate transformer.

In the steering motor abnormality detection device according to one aspect of the present disclosure, the processor may execute the one or more instructions to input error data related to a difference between the one or more estimation values and the one or more actual measurement values to an abnormality detection model and determine whether the steering motor is abnormal.

In the steering motor abnormality detection device according to one aspect of the present disclosure, the abnormality detection model may use a one-class support vector machine (OCSVM) algorithm.

In the steering motor abnormality detection device according to one aspect of the present disclosure, there may be a plurality of data sets each including the input value, the one or more estimation values, and the one or more actual measurement values, and the error data may include an average and a standard deviation of errors between the actual measurement values and the estimation values obtained from the plurality of data sets, a maximum absolute error between the actual measurement values and the estimation values of the plurality of data sets, and discrimination values of the discriminator for actual measurement data obtained from the plurality of data sets.

In the steering motor abnormality detection device according to one aspect of the present disclosure, the discriminator may further receive the input value and estimation data including the one or more estimation values and output a discrimination value for the estimation data.

In the steering motor abnormality detection device according to one aspect of the present disclosure, the artificial neural network model may be built by alternately performing learning of the generator and the discriminator, and the input value and the actual measurement value used for the learning may be obtained in a normal state of each of the vehicle and the steering motor.

In accordance with another aspect of the present disclosure, there is provided a steering motor abnormality detection method for detecting abnormality of a steering motor disposed in a steer-by-wire system of a vehicle and configured to provide a reaction force against manipulation of a steering wheel, the steering motor abnormality detection method including inputting, by a processor, an input value related to driving of a rack configured to receive a driving force from a wheel actuator driven to correspond to the manipulation of the steering wheel and move a wheel of the vehicle to an artificial neural network model and obtaining one or more estimation values related to steering output by the artificial neural network model and comparing, by the processor, the one or more estimation values with one or more actual measurement values related to the steering and detecting whether the steering motor is abnormal.

In the steering motor abnormality detection method according to one aspect of the present disclosure, the input value may a propulsive force of the rack.

In the steering motor abnormality detection method according to one aspect of the present disclosure, the one or more estimation values may include a first estimation value for a first residual which is a difference between a command value of a steering torque applied to the steering wheel of the vehicle to correspond to the input value and a measurement value of the steering torque, and the one or more actual measurement values may include a first actual measurement value which is an actual measurement value for the first residual.

In the steering motor abnormality detection method according to one aspect of the present disclosure, the one or more estimation values may further include a second estimation value for a second residual which is a difference between a command value of a motor torque transmitted to the steering motor to correspond to the input value and a measurement value of the motor torque, and the one or more actual measurement values may further include a second actual measurement value which is an actual measurement value for the second residual.

In the steering motor abnormality detection method according to one aspect of the present disclosure, the artificial neural network model may be formed in a GAN including a generator configured to receive the input value and generate the one or more estimation values and a discriminator configured to receive the input value and actual measurement data including the one or more actual measurement values and output a discrimination value for the actual measurement data.

In the steering motor abnormality detection method according to one aspect of the present disclosure, the detecting of whether the steering motor is abnormal may include inputting, by the processor, the actual measurement data to the discriminator and obtaining the discrimination value for the actual measurement data generated by the discriminator and inputting, by the processor, error data including the discrimination value for the actual measurement data and values related to a difference between the one or more estimation values and the one or more actual measurement values to an abnormality detection model and obtaining an output of the abnormality detection model.

In the steering motor abnormality detection method according to one aspect of the present disclosure, there may be a plurality of data sets each including the input value, the one or more estimation values, and the one or more actual measurement values, and the error data may include an average and a standard deviation of errors between the actual measurement values and the estimation values obtained from the plurality of data sets, a maximum absolute error between the actual measurement values and the estimation values of the plurality of data sets, and discrimination values of the discriminator for the actual measurement data obtained from the plurality of data sets.

In accordance with another aspect of the present disclosure, there is provided a non-transitory computer-readable storage medium in which a program including at least one instruction for performing the steering motor abnormality detection method is stored.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a schematic view illustrating a configuration of a steer-by-wire system of a vehicle;

FIG. 2 is a view illustrating a detailed configuration and an operation of a steering motor controller of the steer-by-wire system of the vehicle;

FIG. 3 is a view illustrating a configuration of a steering motor abnormality detection device according to one embodiment of the present disclosure;

FIG. 4 is a view illustrating models used for obtaining an estimation value or detecting abnormality in the steering motor abnormality detection device according to one embodiment of the present disclosure;

FIG. 5 is a view illustrating a detailed configuration of an artificial neural network model;

FIG. 6 is a view illustrating a detailed configuration of a generator of the artificial neural network model;

FIG. 7 is a view illustrating an operation of the steering motor abnormality detection device according to one embodiment of the present disclosure;

FIG. 8 is a flowchart illustrating a steering motor abnormality detection method according to one embodiment of the present disclosure; and

FIG. 9 is a detailed flowchart illustrating detecting whether a steering motor is abnormal in the steering motor abnormality detection method according to one embodiment of the present disclosure.

### DETAILED DESCRIPTION OF EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their invention.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

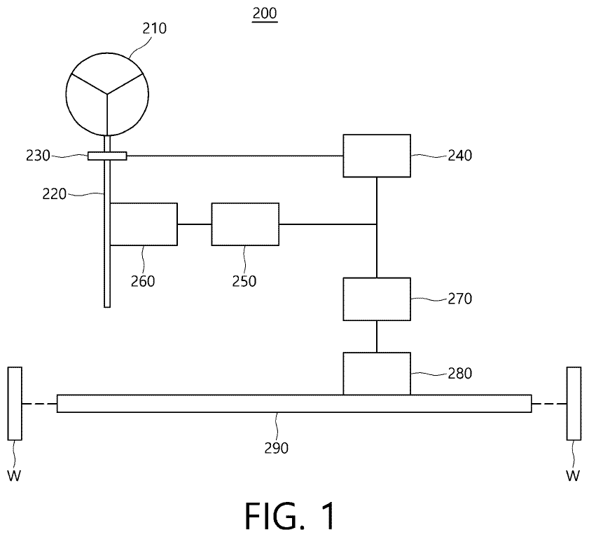

FIG. 1 is a schematic view illustrating a configuration of a steer-by-wire system of a vehicle.

A steer-by-wire system 200 is a steering system for transmitting a steering intention of a driver to a wheel W of the vehicle through an electric signal without mechanical connection between a steering wheel 210 of the vehicle and the wheel W of the vehicle. In the steer-by-wire system, a steering column 220 coupled to the steering wheel 210 does not have any mechanical connection structure with the wheel W of the vehicle.

When the driver of the vehicle manipulates the steering wheel 210, a steering sensor 230 detects one or more of a steering torque and a steering angular speed. In other words, the steering sensor 230 may include one or more of a torque sensor and a steering angle sensor.

In addition, the steer-by-wire system 200 includes a steering motor 260 for providing a reaction force corresponding to manipulation of the steering wheel 210 to the driver and a wheel actuating motor 280 for moving the wheel W. The steering motor 260 provides a steering feeling to the driver. In addition, the wheel actuating motor 280 moves a rack 290 connected to the wheel W. As the rack 290 is moved according to driving of the wheel actuating motor 280, the vehicle may be steered.

Meanwhile, sensing information of the steering sensor 230 is transmitted to an electronic control unit 240. The electronic control unit 240 may transmit a control signal to a steering motor controller 250 for controlling the steering motor 260 and a wheel actuating motor controller 270 for controlling the wheel actuating motor 280 on the basis of the sensing information of the steering sensor 230.

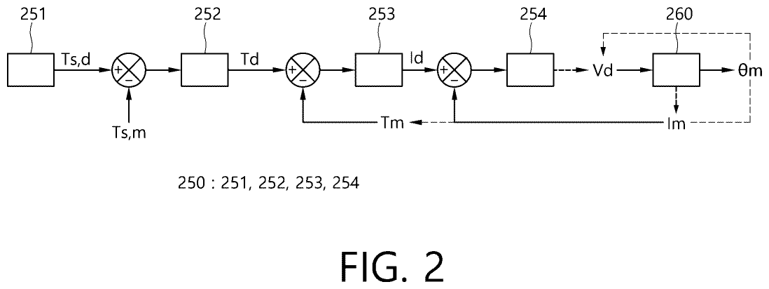

FIG. 2 is a view illustrating a detailed configuration and an operation of the steering motor controller of the steer-by-wire system of the vehicle.

Referring to FIG. 2, the steering motor controller 250 may include a command generator 251, a steering torque controller 252, a steering motor torque controller 253, and a steering motor current controller 254.

The command generator 251 generates a command steering torque Ts,d which is a torque to be applied to the steering wheel 210 to correspond to an input value. In this case, a propulsive force of the rack 290 may be the input value.

The steering torque controller 252 receives a difference between the command steering torque Ts,d and a measurement steering torque Ts,m measured from the steering wheel 210 and generates a command steering motor torque Td which is a torque to be generated by the steering motor 260. For example, the measurement steering torque Ts,m may be measured by the steering sensor 230.

The difference between the command steering torque Ts,d and the measurement steering torque Ts,m may be a difference between a command value of a steering torque and a measurement value of the steering torque and may be defined as a first residual. In other words, the steering torque controller 252 may receive the first residual and generate the command steering motor torque Td.

The steering motor torque controller 253 receives a difference between the command steering motor torque Td and a measurement steering motor torque Tm measured from the steering motor 260 and generates a command current Id which is a current to be supplied to the steering motor 260.

The difference between the command steering motor torque Td and the measurement steering motor torque Tm may be a difference between a command value of a motor torque and a measurement value of the motor torque and may be defined as a second residual. In other words, the steering motor torque controller 253 may receive the second residual and generate the command current Id.

The steering motor current controller 254 receives a difference between the command current Id and a measurement current Im of the motor and controls a current supplied to the steering motor 260. Accordingly, a voltage Vd input to the steering motor 260 may be determined. Meanwhile, the measurement current Im of the motor may be calculated from an angle θm (position) of the steering motor 260. In addition, the measurement steering motor torque Tm may be estimated from the measurement current Im of the steering motor 260.

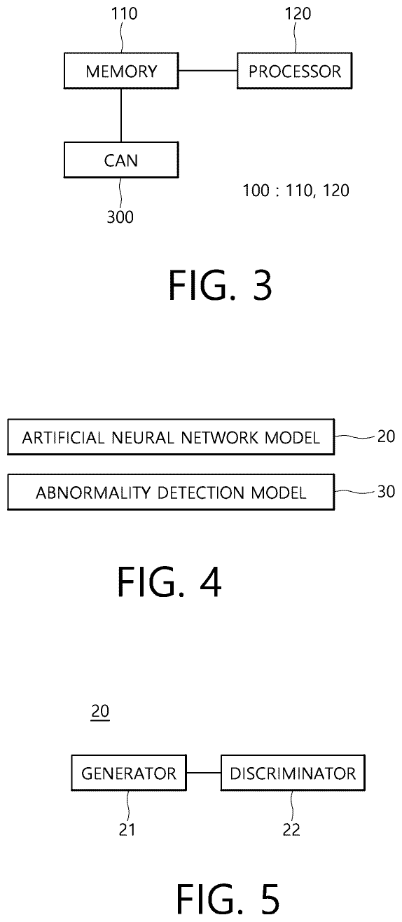

FIG. 3 is a view illustrating a configuration of a steering motor abnormality detection device according to one embodiment of the present disclosure. In addition, FIG. 4 is a view illustrating models used for obtaining an estimation value or detecting abnormality in the steering motor abnormality detection device according to one embodiment of the present disclosure.

A steering motor abnormality detection device 100 according to one embodiment of the present disclosure detects abnormality of the steering motor 260 which is disposed in the steer-by-wire system 200 of the vehicle and provides a reaction force against manipulation of the steering wheel 210. More specifically, the steering motor abnormality detection device 100 may detect output reduction before the steering motor 260 completely fails.

The steering motor abnormality detection device 100 according to one embodiment of the present disclosure may prognose functional degradation of the steering motor 260 before the steering motor 260 fails through a digital twin algorithm based on an artificial intelligence. The digital twin algorithm may virtually build the steer-by-wire system of the vehicle.

Referring to FIG. 3, the steering motor abnormality detection device 100 according to one embodiment of the present disclosure may include a memory 110 and a processor 120.

The memory 110 stores one or more instructions. The one or more instructions may be executed by the processor 120.

The memory 110 may include a hardware device configured to store and execute a program instruction. For example, the memory 110 may include storage media such as a read only memory (ROM), a random-access memory (RAM), and a flash memory. In addition, the memory 110 may also include magnetic media such as a floppy disk and a magnetic tape, optical media such as a compact disk read only memory (CD-ROM) and a digital video disk (DVD), magneto-optical media such as a floptical disk, etc.

The processor 120 executes the one or more instructions. For example, the processor 120 may be a hardware unit which performs an operation and control in a computer. The processor 120 may include at least one arithmetic logic unit (ALU) and a register.

The processor 120 executes the one or more instructions to input an input value related to driving of the rack 290 to an artificial neural network model 20 and obtain one or more estimation values related to steering output by the artificial neural network model 20, wherein the rack 290 receives a driving force from a wheel actuator driven to correspond to manipulation of the steering wheel 210 and moves the wheel W of the vehicle. In this case, the wheel actuator may be the wheel actuating motor 280 described above.

A propulsive force of the rack 290 may be the input value. The propulsive force of the rack may be obtained through a controller area network (CAN) 300. For example, the wheel actuating motor controller 270 receives the propulsive force of the rack and transmits propulsive force information of the rack through the CAN 300.

As described above, the input value may be obtained through the CAN 300 of the vehicle. Accordingly, in the case of the present disclosure, an additional sensor related to abnormality detection of the steering motor 260 does not need to be used.

In this regard, the memory 110 may be directly or indirectly connected to the CAN 300 of the vehicle. The memory 110 may receive the input value through the CAN 300. Accordingly, the processor 120 may obtain the input value from the memory 110.

The one or more estimation values may include a first estimation value for the first residual which is the difference between the command value of the steering torque applied to the steering wheel 210 to correspond to the input value and the measurement value of the steering torque. In addition, the one or more estimation values may further include a second estimation value for the second residual which is the difference between the command value of the motor torque transmitted to the steering motor 260 to correspond to the input value and the measurement value of the motor torque.

The artificial neural network model 20 receives the input value and outputs the one or more estimation values. The artificial neural network model 20 may receive the input value and output the first estimation value and the second estimation value.

The one or more estimation values are obtained to be compared with one or more actual measurement values related to steering. In this case, the one or more actual measurement values may include a first actual measurement value which is an actual measurement value for the first residual and a second actual measurement value which is an actual measurement value for the second residual.

In one embodiment of the present disclosure, the artificial neural network model 20 may be formed in a generative adversarial network (GAN).

In one embodiment of the present disclosure, the artificial neural network model 20 may be a neural twin model based on deep learning for the steer-by-wire system of the vehicle. In other words, the artificial neural network model 20 may serve as a virtual twin model of the steer-by-wire system of the vehicle.

FIG. 5 is a view illustrating a detailed configuration of an artificial neural network model.

Referring to FIG. 5, the artificial neural network model 20 may include a generator 21 and a discriminator 22.

The artificial neural network model 20 may be built by alternately performing learning of the generator 21 and the discriminator 22, and data used for the learning may be obtained in a normal state of each of the vehicle and the steer-by-wire system. Accordingly, the one or more estimation values may follow the actual measurement value for the first residual and the actual measurement value for the second residual obtained in a normal state of each of the vehicle and the steer-by-wire system.

The generator 21 receives the input value and generates the one or more estimation values. The generator 21 may include a neural network. The generator 21 may be provided as a multivariate transformer. That is, the artificial neural network model 20 may be the GAN based on the multivariate transformer.

In one embodiment of the present disclosure, the generator 21 may receive the input value related to driving of the rack which receives the driving force from the wheel actuator driven to correspond to manipulation of the steering wheel and moves the wheel of the vehicle. As described above, the propulsive force of the rack may be the input value.

The generator 21 may operate the input value to output the one or more estimation values. More specifically, the generator 21 may output the estimation value for the first residual and the estimation value for the second residual.

The estimation values estimated by the generator 21 follow the actual measurement value for the first residual and the actual measurement value for the second residual which are output to correspond to the input value when the steer-by-wire system of the vehicle is normal.

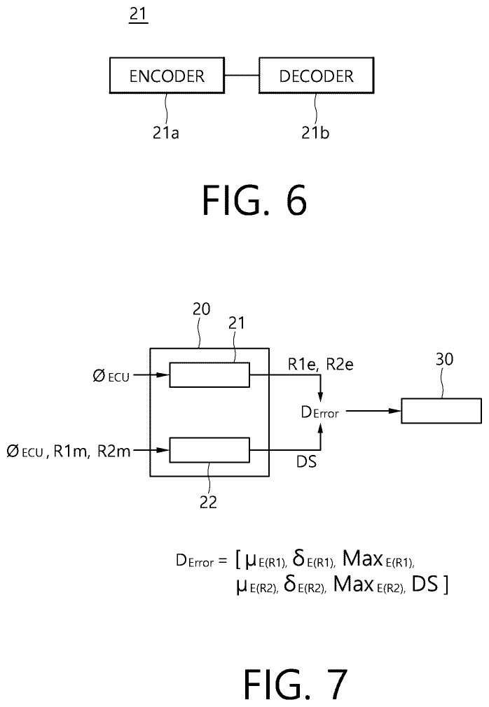

FIG. 6 is a view illustrating a detailed configuration of the generator of the artificial neural network model.

Referring to FIG. 6, the generator 21 may include an encoder 21a and a decoder 21b.

The encoder 21a and the decoder 21b constitute a network for estimating one or more estimation values related to steering of the vehicle. In other words, the generator 21 may be formed in the network with an encoder 21a-decoder 21b structure trained in an end-to-end method to estimate the one or more estimation values.

The encoder 21a may be designed to extract high-level features from the input value using a transformer block and a linear operation. In this case, the transformer block may include an embedding layer, a self-attention layer, and a feed-forward layer.

First, in the transformer block, the embedding layer may encode spatiotemporal information into input sequences using a trainable embedding matrix.

Next, deep features may be extracted through the self-attention layer, and refinement may be performed using the feed-forward layer.

In this case, the self-attention layer may use a scaled dot-product attention mechanism. The self-attention layer may be an important component in a deep neural network (DNN) architecture based on a transformer which allows a model to process and understand dependence in an input sequence.

The scaled dot-product attention may apply layer normalization to the input sequence first, and process a result thereof as three unique vectors of a quarry Q, a key K, and a value V through the linear operation.

Next, an attention score AS for each position of the input sequence may be calculated on the basis of induced vectors. A calculation equation of the attention score AS may be given as Equation 1 below.

$$AS = σ ( \frac{Q \cdot K}{\sqrt{{‖ {x}_{input} ‖}_{dim}}} ) \cdot V \qquad [ Equation 1 ]$$

(σ(·) means a softmax operation, ∥xᵢₙₚᵤₜ∥_{dim} means an input feature dimension, and (·) means dot-product.)

The attention score quantifies relative importance of each position in the input sequence related to a given quarry. That is, a higher score is assigned to a more appropriate position.

An output of the transformer block may be provided to two different linear operations in order to calculate a quarry, a key vector, and an initial input value ŷ₁ of the decoder 21b.

The decoder 21b may use obtained values to estimate one or more estimation values in an automatic regression method similar to sequence-to-sequence recurrent neural networks.

Like the encoder 21a, the decoder 21b may include a transformer block and a linear operation. The decoder 21b may also further includes a cross-attention layer in the transformer block.

The cross-attention layer may perform a scaled dot-product attention using the quarry and the key vector of the encoder 21a in order to training a dynamic correlation between an input signal and an estimation signal.

The discriminator 22 receives the input value and actual measurement data including the one or more actual measurement values and outputs a discrimination value for the actual measurement data.

The discriminator 22 is a classifier that aims to determine the conditional probability. The discriminator 22 determines the probability of an example being real or fake given that set of input features. The discrimination value from the discriminator 22 are classification labels. For example, the discrimination value from the discriminator 22 is 0 or 1.

Meanwhile, the discriminator 22 may further receive the input value and estimation data including the one or more estimation values and output a discrimination value for the estimation data. This process may be performed while the generator 21 and the discriminator 22 perform leaning.

As described above, the discriminator 22 may output the discrimination value for the actual measurement data in an operation process of detecting abnormality, and the discrimination value for the estimation data in an operation process of training.

The discriminator 22 may be formed in a discrimination network used for adversary training the GAN. In other words, the generator 21 and the discriminator 22 may be trained in an adversary training method to improve estimation performance and set a GAN model.

More specifically, optimization of the discriminator 22 and the generator 21 may be alternately performed in order to solve a Wasserstein min-max problem as in Equation 2.

$${min}_{G} {max}_{D} {E}_{{x}_{D , Real}} [ D ( {x}_{D , Real} ) ] - {E}_{{x}_{D , Fake}} [ D ( {x}_{D , Fake} ) ] \qquad [ Equation 2 ]$$

(x_{D,Real} denotes an actual data set including input data and an actual measurement value related to steering, and x_{D,Fake} means a virtual data sample including the input data and an estimation value related to steering.)

In the artificial neural network model 20, the generator 21 is trained to deceive the discriminator 22 which classifies spatiotemporal characteristics of x_{D,Real} and x_{D,Fake}. Accordingly, the generator 21 may generate an estimation value following the steer-by-wire system in the normal state.

In this regard, a loss function for training the GAN may be defined as in Equation 3 below.

$${L}_{G} = \frac{1}{N} \sum \vert {y}_{G} - {\hat{y}}_{G} \vert + 0.001 \times \frac{1}{N} \sum [ - D ( {x}_{D , Fake} ) ] . \\ {L}_{D} = \frac{1}{N} \sum [ D ( {x}_{D , Fake} ) - D ( {x}_{D , Real} ) + 10 \times \frac{1}{N} \sum [ {( {‖ {∇}_{{x}_{D , Fake}} D ( {x}_{D , Fake} ) ‖}_{2} - 1 )}^{2} ] \qquad [ Equation 3 ]$$

(N is an arrangement size, L_{G} is a loss function of the generator, and L_{D} is a loss function of the discriminator.)

A first loss item of the generator 21 corresponds to an average absolute error loss L_{MAE} of guidance training. The remaining loss item of the generator 21 constitutes a GAN loss function L_{GAN} with a loss of the discriminator 22.

The processor 120 compares the one or more estimation values with one or more actual measurement values related to steering to detect whether the steering motor is abnormal. As described above, the one or more estimation values may include the first estimation value for the first residual and the second estimation value for the second residual. In addition, the one or more actual measurement values may include the first actual measurement value which is the actual measurement value for the first residual and the second actual measurement value which is the actual measurement value for the second residual.

The processor 120 may execute the one or more instructions to input error data related to the difference between the one or more estimation values and the one or more actual measurement values to the abnormality detection model 30 to determine whether the steering motor is abnormal. For example, the abnormality detection model 30 may use a one-class support vector machine (OCSVM) algorithm.

There may be a plurality of data sets each including the input value, the one or more estimation values, and the one or more actual measurement values. The error data may include an average and a standard deviation of errors between actual measurement values and estimation values obtained from the plurality of data sets, a maximum absolute error between the actual measurement values and the estimation values of the plurality of data sets, and discrimination values of the discriminator for the actual measurement data obtained from the plurality of data sets.

In one embodiment of the present disclosure, the error data may include an average of errors between first estimation values and first actual measurement values, a standard deviation of the errors between the first estimation values and the first actual measurement value, a maximum absolute error between the first estimation values and the first actual measurement values, an average of errors between second estimation values and second actual measurement values, a standard deviation of the errors between the second estimation values and the second actual measurement values, a maximum absolute error between the second estimation values and the second actual measurement values, and discrimination values of the discriminator for the input value and actual measurement data including the first actual measurement values and the second actual measurement values.

A plurality of data sets each including the one or more estimation values and the one or more actual measurement values may be processed as one batch. For example, 100 to 150 data sets (specifically, 128 data set) may be processed as one batch, and the error data may be obtained for each batch.

The error data obtained for one batch may be input to the abnormality detection model 30. In addition, a level of abnormality of the steering motor (performance degradation of the steering motor) may be detected on the basis of an output (feature) obtained from the abnormality detection model 30 which receives the error data.

An F1 score given as in Equation 4 may be considered in relation to an anomaly detection metric.

$$F 1 = \frac{2 \times TP}{2 \times TP + FP + FN} \qquad [ Equation 4 ]$$

(TP denotes a true positive, FP denotes a false positive, FN denotes a false negative, and positive denotes performance degradation of the steering motor.)

Meanwhile, as described above, the discriminator 22 may calculate not only the discrimination value for the actual measurement data included in the data set but also the discrimination value for the estimation data included in the data set. The discrimination value of the discriminator 22 for the estimation data of the data set may be fed back to the generator 21 of the artificial neural network model 20 and used for training.

The configuration of the steering motor abnormality detection device 100 according to one embodiment of the present disclosure has been described in detail. Hereinafter, an operation of the steering motor abnormality detection device 100 will be described in detail.

FIG. 7 is a view illustrating an operation of the steering motor abnormality detection device according to one embodiment of the present disclosure.

Referring to FIG. 7, the steering motor abnormality detection device 100 according to one embodiment of the present disclosure may operate as described below.

First, the memory 110 stores an input value Ø_{ECU} and one or more actual measurement values. In this case, the one or more actual measurement values may include a first actual measurement value R1m of a first residual which is actually measured and a second actual measurement value R2m of a second residual which is actually measured.

As described above, the input value Ø_{ECU} may be a propulsive force of the rack. In addition, a plurality of input values Ø_{ECU}, first actual measurement values R1m, and second actual measurement values R2m may be processed as one batch. That is, in one embodiment of the present disclosure, a data processing and an operation may be performed in units of batches.

Next, the processor 120 executes one or more instructions to input the input value Ø_{ECU} to the artificial neural network model 20 and obtains one or more estimation values output by the artificial neural network model 20. More specifically, the processor 120 may input the input value Ø_{ECU} to the generator 21 of the artificial neural network model 20 and obtain a first estimation value R1e which is an estimation value for the first residual and a second estimation value R2e which is an estimation value for the second residual which are output by the generator 21.

In addition, the processor 120 executes one or more instructions to input the input value Ø_{ECU}, the first actual measurement value R1m, and the second actual measurement value R2m to the artificial neural network model 20 and obtains a discrimination value DS. More specifically, the processor 120 may input the input value Ø_{ECU}, first actual measurement data including the first actual measurement value R1m, and second actual measurement data including the second actual measurement value R2m to the discriminator 22 and obtains the discrimination value DS.

Next, the processor 120 outputs error data D_{Error}. The error data D_{Error} may be output for each batch.

More specifically, there may be a plurality of data sets each including the input value, the one or more estimation values, and the one or more actual measurement values.

In this case, the error data D_{Error} may include an average μ_{E(R1)} of errors between first estimation values R1e and first actual measurement values R1m, a standard deviation σ_{E(R1)} of the errors between the first estimation values R1e and the first actual measurement values R1m and a maximum absolute error Max_{E(R1)} between the first estimation values R1e and the first actual measurement values R1m, an average μ_{E(R2)} of errors between second estimation values R2e and second actual measurement values R2m, a standard deviation OF (R2) of the errors between the second estimation values R2e and the second actual measurement values R2m, a maximum absolute error Max_{E(R2)} between the second estimation values R2e and the second actual measurement values R2m, and discrimination values DS of the discriminator for the input value Ø_{ECU}, the first actual measurement data including the first actual measurement values R1m, and the second actual measurement data including the second actual measurement values R2m.

Finally, the processor 120 executes one or more instructions to input the error data D_{Error} to the abnormality detection model 30 and outputs an output of the abnormality detection model 30. As described above, the abnormality detection model 30 may include the OCSVM algorithm.

The processor 120 may detect a level of abnormality of the steering motor (performance degradation of the steering motor) of the steer-by-wire system on the basis of an output (feature) obtained from the abnormality detection model 30 which receives the error data D_{Error}.

As described above, the steering motor abnormality detection device 100 according to one embodiment of the present disclosure has been described in detail. Hereinafter, a steering motor abnormality detection method will be described.

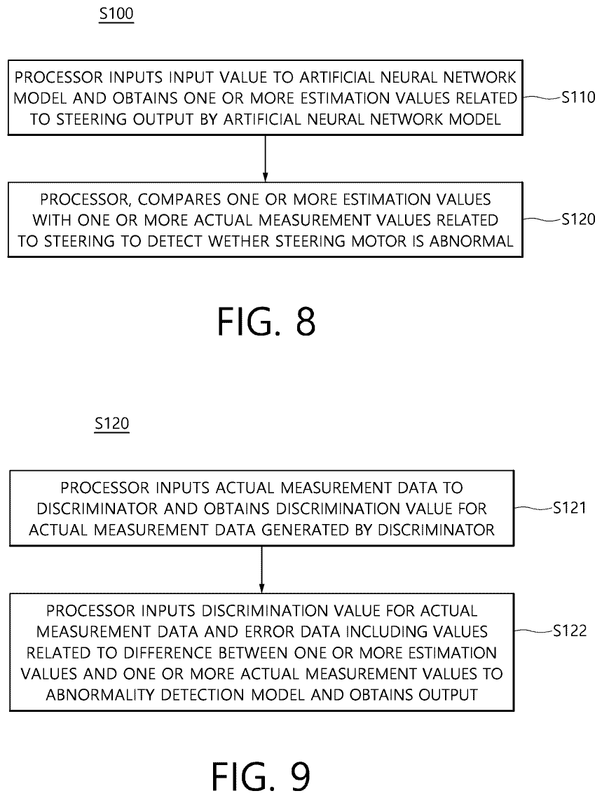

FIG. 8 is a flowchart illustrating the steering motor abnormality detection method according to one embodiment of the present disclosure.

In a steering motor abnormality detection method S100 according to one embodiment of the present disclosure, abnormality of the steering motor, which is disposed in the steer-by-wire system of the vehicle and provides a reaction force against manipulation of the steering wheel, is detected.

Referring to FIG. 8, the steering motor abnormality detection method S100 according to one embodiment of the present disclosure may be performed as follows.

First, the processor 120 inputs an input value related to driving of the rack to the artificial neural network model 20 and obtains one or more estimation values related to steering output by the artificial neural network model 20, wherein the rack receives a driving force from the wheel actuator driven to correspond to manipulation of the steering wheel and moves the wheel of the vehicle (S110).

A propulsive force of the rack may be the input value. For example, the propulsive force of the rack may be obtained through the CAN of the vehicle 300.

The one or more estimation values may include a first estimation value for a first residual which is a difference between a command value of a steering torque applied to the steering wheel 210 to correspond to the input value and a measurement value of the steering torque. In addition, the one or more estimation values may further include a second estimation value for a second residual which is a difference between a command value of a motor torque transmitted to the steering motor 260 to correspond to the input value and a measurement value of the motor torque.

The one or more estimation values are obtained to be compared with one or more actual measurement values related to steering. In this case, the one or more actual measurement values may include a first actual measurement value which is an actual measurement value for the first residual and a second actual measurement value which is an actual measurement value for the second residual.

In one embodiment of the present disclosure, the artificial neural network model 20 may include the GAN. In other words, the artificial neural network model 20 may be the neural twin model based on deep learning for the steer-by-wire system of the vehicle.

The artificial neural network model 20 may include the generator 21 and the discriminator 22. The generator 21 receives the input value and generates the one or more estimation values. The generator 21 may be provided as the multivariate transformer. In addition, the discriminator 22 may receive the input value and actual measurement data including the one or more actual measurement values and output a discrimination value for the actual measurement data.

In operation S110 of obtaining the one or more estimation values, the processor 120 may input the input value to the generator 21 and obtain the one or more estimation values generated by the generator 21.

Meanwhile, the artificial neural network model 20 may be built by performing learning of the generator 21 and the discriminator 22, and the input value and the one or more actual measurement values used for the learning may be obtained in a normal state of each of the vehicle and the steer-by-wire system. Accordingly, the one or more estimation values may follow the actual measurement values related to steering in the normal state of the steer-by-wire system.

Next, the processor 120 compares the one or more estimation values with the one or more actual measurement values related to the steering to detect whether the steering motor is abnormal (S120).

The processor 120 may execute one or more instructions to input error data related to the difference between the one or more estimation values and the actual measurement values to the abnormality detection model 30 to determine whether the steering motor is abnormal. For example, the abnormality detection model 30 may use the OCSVM algorithm.

FIG. 9 is a detailed flowchart illustrating detecting whether the steering motor is abnormal in the steering motor abnormality detection method according to one embodiment of the present disclosure.

Referring to FIG. 9, operation S120 of detecting whether the steering motor is abnormal may be performed as follows.

First, the processor 120 inputs the input value and the actual measurement data including the one or more actual measurement values to the discriminator 22 and obtains a discrimination value for the actual measurement data generated by the discriminator 22 (S121).

Next, the processor 120 inputs the discrimination value for the actual measurement data and the error data including values related to differences between the one or more estimation values and one or more actual measurement values to the abnormality detection model 30 and obtains an output of the abnormality detection model 30 (S122).

There may be a plurality of data sets each including the input value, the one or more estimation values, and the one or more actual measurement values. The error data may include an average and a standard deviation of errors between the actual measurement values and the estimation values obtained from the plurality of data sets, a maximum absolute error between the actual measurement values and the estimation values of the plurality of data sets, and discrimination values of the discriminator for actual measurement data obtained from the plurality of data sets.

In one embodiment of the present disclosure, the error data may include an average of errors between first estimation values and first actual measurement values, a standard deviation of the errors between the first estimation values and the first actual measurement values, a maximum absolute error between the first estimation values and the first actual measurement values, an average of errors between second estimation values and second actual measurement values, a standard deviation of the errors between the second estimation values and the second actual measurement values, a maximum absolute error between the second estimation values and the second actual measurement values, discrimination values of the discriminator for the input value, first actual measurement data including the first actual measurement values, and second actual measurement data including the second actual measurement values.

A plurality of data sets each including the one or more estimation values and the one or more actual measurement values may be processed as one batch. For example, 100 to 150 data sets (specifically, 128 data sets) may be processed as one batch, and the error data may be obtained for each batch.

The error data obtained for one batch may be input to the abnormality detection model 30. In addition, a level of the abnormality of the steering motor (performance degradation of the steering motor) may be detected on the basis of an output (feature) obtained from the abnormality detection model 30 which receives the error data.

Meanwhile, the present disclosure further provides the non-transitory computer-readable storage medium in which a program for performing the steering motor abnormality detection method is stored. Specifically, the present disclosure may provide the non-transitory computer-readable storage medium in which the program including at least one instruction for performing the steering motor abnormality detection method is stored.

In this case, the instruction may include a machine code generated by a compiler. In addition, the instruction may also include a high-level language code which may be executed by a computer.

The storage medium may include a hardware device, such as magnetic media including a hard disk, a floppy disk, and a magnetic tape, optical media including a CD-ROM and a DVD, a magneto-optical media including a floptical disk, a ROM, a RAM, and a flash memory which are configured to store and execute a program instruction.

The above described F1 score may be considered in relation to an anomaly detection metric.

As a result of simulation, in the case of the present disclosure, it is seen that performance of the steering motor can be predicted to be degraded to 10% of a maximum output power thereof with a F1 score of 0.85 or more. In other words, in the case of the present disclosure, a degradation level of the steering motor, which is disposed in the steer-by-wire system and provides a reaction force against manipulation of the steering the wheel, can be accurately predicted before the steering motor completely fails.

According to the present disclosure, failure of the steering motor of the steer-by-wire system can be predicted before occurring. As a result, a proactive measure can be performed before the steering motor fails, and the failure of the steering motor can be effectively prevented.

As described above, the present disclosure provides estimation of a future operation and remaining effective lifetime of a system and prognostic proper to a predictive maintenance application. Accordingly, a proactive measure and maintenance can be effectively guided before the steering motor of the steer-by-wire system fails.

According to the above described configuration, the steering motor abnormality detection device and method and the non-transitory computer-readable storage medium in which a program for performing the method according to one aspect of the present disclosure is stored can prognose performance degradation of the steer motor which is disposed in the steer-by-wire system of the vehicle based on the digital twin algorithm based on artificial intelligence and provides a reaction force against manipulation of the steering wheel before the steering motor fails.

In addition, the steering motor abnormality detection device and method and the non-transitory computer-readable storage medium in which a program for performing the method is stored can predict performance degradation of the steering motor using CAN signals of the vehicle without an additional sensor.

It should be understood that the effects of the present disclosure are not limited to the above-described effects, and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A device comprising:
a memory configured to store one or more instructions; and
a processor configured to execute the one or more instructions comprising:
inputting an input value, related to driving of a rack configured to be movable by a driving force generated from a wheel actuator driven in response to manipulation of a steering wheel to move a wheel of a vehicle, to an artificial neural network model;
obtaining one or more estimation values, related to steering of the vehicle, from the artificial neural network model; and
detecting whether a steering motor included in a steer-by-wire system of the vehicle and configured to provide a reaction force against the manipulation of the steering wheel is in an abnormal state by comparing the one or more estimation values, obtained from the artificial neural network model, with one or more actual measurement values related to the steering of the vehicle.

2. The device of claim 1, wherein the input value related to the driving of the rack comprises a propulsive force of the rack.

3. The device of claim 1, wherein:
the one or more estimation values obtained from the artificial neural network model include a first estimation value for a first residual which is a difference between a command value of a steering torque applied to the steering wheel to correspond to the input value and a measurement value of the steering torque; and
the one or more actual measurement values include a first actual measurement value which is an actual measurement value for the first residual.

4. The device of claim 3, wherein:
the one or more estimation values obtained from the artificial neural network model further include a second estimation value for a second residual which is a difference between a command value of a motor torque transmitted to the steering motor to correspond to the input value and a measurement value of the motor torque; and
the one or more actual measurement values further include a second actual measurement value which is an actual measurement value for the second residual.

5. The device of claim 1, wherein the processor is configured to obtain the input value through a controller area network (CAN) of the vehicle.

6. The device of claim 1, wherein the artificial neural network model is comprised in a generative adversarial network (GAN) including a generator configured to receive the input value, related to the driving of the rack, and generate the one or more estimation values; and a discriminator configured to, in response to the input value, related to the driving of the rack, and actual measurement data including the one or more actual measurement values, output a discrimination value for the actual measurement data.

7. The device of claim 6, wherein the generator comprises a multivariate transformer.

8. The device of claim 6, wherein the processor is configured to input error data related to a difference between the one or more estimation values and the one or more actual measurement values to an abnormality detection model, and determine whether the steering motor is in the abnormal state based on an output of the abnormality detection model.

9. The device of claim 8, wherein the abnormality detection model is configured to use a one-class support vector machine (OCSVM) algorithm.

10. The device of claim 8, wherein:
each of a plurality of data sets includes the input value, the one or more estimation values, and the one or more actual measurement values; and
the error data includes an average and a standard deviation of errors between actual measurement values and estimation values of the plurality of data sets, a maximum absolute error between the actual measurement values and the estimation values of the plurality of data sets, and discrimination values of the discriminator for actual measurement data of the plurality of data sets.

11. The device of claim 6, wherein the discriminator is further configured to, in response to the input value and estimation data including the one or more estimation values, output a discrimination value for the estimation data.

12. The device of claim 11, wherein:
the artificial neural network model is configured to alternately perform learning of the generator and the discriminator; and
the processor is configured to obtain the input value and the actual measurement value used for the learning of the generator and the discriminator when the vehicle and the steering motor are in a normal state.

13. A computerized method comprising:
inputting an input value, related to driving of a rack configured to be movable by a driving force generated from a wheel actuator driven in response to manipulation of a steering wheel to move a wheel of the vehicle, to an artificial neural network model;
obtaining one or more estimation values, related to steering of the vehicle, from the artificial neural network model; and
detecting whether a steering motor included in a steer-by-wire system of the vehicle and configured to provide a reaction force against the manipulation of the steering wheel is in an abnormal state by comparing the one or more estimation values, obtained from the artificial neural network model, with one or more actual measurement values related to the steering of the vehicle.

14. The method of claim 13, wherein the input value related to the driving of the rack comprises a propulsive force of the rack.

15. The method of claim 13, wherein:
the one or more estimation values obtained from the artificial neural network model include a first estimation value for a first residual which is a difference between a command value of a steering torque applied to the steering wheel to correspond to the input value and a measurement value of the steering torque; and
the one or more actual measurement values include a first actual measurement value which is an actual measurement value for the first residual.

16. The method of claim 15, wherein:
the one or more estimation values obtained from the artificial neural network model further include a second estimation value for a second residual which is a difference between a command value of a motor torque transmitted to the steering motor to correspond to the input value and a measurement value of the motor torque; and
the one or more actual measurement values further include a second actual measurement value which is an actual measurement value for the second residual.

17. The method of claim 13, wherein the artificial neural network model is comprised in a generative adversarial network (GAN) including a generator configured to receive the input value, related to the driving of the rack, and generate the one or more estimation values; and a discriminator configured to, in response to the input value, related to the driving of the rack, and actual measurement data including the one or more actual measurement values, output a discrimination value for the actual measurement data.

18. The method of claim 17, wherein the detecting of whether the steering motor is in the abnormal state comprises:
by inputting the actual measurement data to the discriminator, obtaining the discrimination value for the actual measurement data generated by the discriminator; and
by inputting error data including the discrimination value for the actual measurement data and values related to a difference between the one or more estimation values and the one or more actual measurement values to an abnormality detection model, obtaining an output from the abnormality detection model.

19. The method of claim 18, wherein:
each of a plurality of data sets includes the input value, the one or more estimation values, and the one or more actual measurement values; and
the error data includes an average and a standard deviation of errors between actual measurement values and estimation values of the plurality of data sets, a maximum absolute error between the actual measurement values and the estimation values of the plurality of data sets, and discrimination values of the discriminator for the actual measurement data of the plurality of data sets.

20. A non-transitory computer-readable storage medium configured to instructions that when executed by one or more processors, cause the one or more processors to perform operations comprising:
inputting an input value, related to driving of a rack configured to be movable by a driving force generated from a wheel actuator driven in response to manipulation of a steering wheel to move a wheel of the vehicle, to an artificial neural network model;
obtaining one or more estimation values, related to steering of the vehicle, from the artificial neural network model; and
detecting whether a steering motor included in a steer-by-wire system of the vehicle and configured to provide a reaction force against the manipulation of the steering wheel is in an abnormal state by comparing the one or more estimation values, obtained from the artificial neural network model, with one or more actual measurement values related to the steering of the vehicle.
